(19) United States
(12) Patent Application Publication
(10) Pub. No.: US 2025/0384207 A1
(43) Pub. Date: Dec. 18, 2025

(54) DYNAMIC EVALUATION SYSTEM FOR RESPONSIBLE AI IN LARGE LANGUAGE MODELS

(71) Applicant: Microsoft Technology Licensing, LLC, Redmond, WA (US)

(72) Inventors: Parag AGRAWAL, Bengaluru (IN); Hari SHRAWGI, Hyderabad (IN); Tushar SINGHAL, Bengaluru (IN); Madhur JINDAL, Bengaluru (IN); Prasenjit GHOSH, Bengaluru (IN); Sandipan DANDAPAT, Hyderabad (IN); Prasanjit RATH, Hyderabad (IN)

(73) Assignee: Microsoft Technology Licensing, LLC, Redmond, WA (US)

(21) Appl. No.: 18/742,627

(22) Filed: Jun. 13, 2024

(51) Int. Cl. G06F 40/20; G06F 21/10; H04L 51/02

(52) U.S. Cl. CPC G06F 40/20; G06F 21/10; H04L 51/02

(57) ABSTRACT

The technology described herein, among other things, relates to testing applications, backed by language models (LMs), for compliance with responsible artificial-intelligence (RAI) guidelines. For example, LM-based chatbots have proliferated across many different domains and implementations. These chatbots, however, may be susceptible to attacks or attempts to cause the chatbots to violate RAI guidelines by producing harmful content and/or potentially violating copyrights. To evaluate whether an LM-based application, such as a chatbot, is complying with respective RAI guidelines, the technology disclosed herein adaptively simulates conversations with the LM-based application in an attempt to cause the LM-based application to violate the RAI guidelines in a controlled, simulated environment.

### BACKGROUND

Interactions with generative artificial intelligence (AI) models may often occur in a chat-based format. For instance, natural language inputs are provided to a chat interface. Those natural language inputs are combined into a prompt that is provided to the AI model to process. The output of the AI model is then provided as a response to the natural language inputs. These input/output pairs may continue for several turns as part of a thread or pseudo-conversation with the AI model.

It is with respect to these limitations and other considerations that examples have been made. In addition, although relatively specific problems have been discussed, it should be understood that the examples should not be limited to solving the specific problems identified in the background.

### SUMMARY

The technology described herein, among other things, relates to testing applications, backed by language models (LMs), for compliance with responsible artificial-intelligence (RAI) guidelines. For example, LM-based chatbots have proliferated across many different domains and implementations. These chatbots, however, may be susceptible to attacks or attempts to cause the chatbots to violate RAI guidelines by producing harmful content and/or potentially violating copyrights. To evaluate whether an LM-based application, such as a chatbot, is complying with respective RAI guidelines, the technology disclosed herein adaptively simulates conversations with the LM-based application in an attempt to cause the LM-based application to violate the RAI guidelines in a controlled, simulated environment.

To do so, the technology uses an initial set of conversation parameters to generate conversational inputs that are transmitted to the LM-based application. The conversational parameters include data such as a system description of the LM-based application, the particular RAI guideline(s) being tested, persona settings for a simulated user, configuration settings for the language model (e.g., top-p, top-k, temperature), and/or adversarial seeds, among others. The LM-based application then provides a conversational response in reply to the conversational input, which forms the beginning of a simulated conversation. Multiple simulated conversations are generated to form a first set of conversations.

The first set of conversations are analyzed to generate feedback about the effectiveness of the first set of conversations in attempting to cause the LM-based application to violate the RAI guideline(s). The feedback may be based on metrics generated for the first set of simulated conversations. The metrics may include metrics such as a relevancy metric, an adversarial metric, and a diversity and coverage metric.

The conversation parameters are then adjusted based on the generated feedback. A second set of simulated conversations is generated based on the adjusted conversation parameters. Feedback may then be generated for the second set of simulated conversations, and conversation parameters are adjusted for further subsequent sets of simulated conversations.

The last-generated set of simulated conversations is evaluated to determine the RAI compliance of the LM-based application. For example, the simulated conversations may be incorporated into an evaluation prompt that is evaluated by a language model to determine if any of the conversational responses provided by the LM-based application violated the RAI guideline(s). An RAI compliance score may then be generated, and a certificate may be issued to the LM-based application indicating compliance.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 depicts a block diagram of an example system for dynamically evaluating an LM-based application.

FIG. 2 depicts a block diagram of another example conversation generator.

FIGS. 3A-3C depict an example interfaces implementing examples of the dynamic evaluation system discussed herein.

FIGS. 4A-4D depict example methods for dynamically evaluating an LM-based application.

FIG. 5 is a block diagram illustrating example physical components of a computing device with which aspects of the disclosure may be practiced.

### DETAILED DESCRIPTION

As discussed briefly above, interactions with generative AI models may occur through a chat-based interface where the generative AI model supports, or provides, the chatbot functionality. As part of the chat, an input or query is received (often from a user operating a user device) and a response is generated by the AI model that processes the input. Each input-output pair may be considered a single “turn.” Multiple turns form a conversation.

In the contemporary landscape of AI, language models (LMs), such as large LMs (LLMs) for example, have proliferated into many different applications, such as search engines and question-and-answer chatbots. With this increase in LLM-supported interfaces, the imperative of ensuring that responsible AI (RAI) practices and principles are adhered to becomes increasingly important and challenging due to the enlarged number of scenarios and interfaces that are supported by the LLMs. In general, RAI is an approach to developing, assessing, and deploying AI systems in a safe, trustworthy, and ethical way. AI systems are the product of many decisions made by those who develop and deploy them. From system purpose to how people interact with AI systems, RAI can help proactively guide these decisions toward more beneficial and equitable outcomes. Addressing RAI entails a multifaceted approach encompassing the implementation of rigorous control mechanisms, detection strategies, and mitigation techniques to mitigate potential ethical, social, and legal ramifications, such as prompt modification, LLM version selection, classifier integration, filtering of grounding data, and/or finetuning and alignment.

In prompt modification, the prompt (provided to the LLM) itself is modified to help guard against improper use. In LLM version selection, a deliberation selection among various versions of the LLMs is performed based on their adherence to RAI standards. In classifier integration, specialized classifiers are employed that detect and filter out problematic content, such as hateful language, bias, and/or other improper sentiments. The filtering of grounding data involves filtering the grounding data that the LLM also uses as input. For example, if the grounding data itself is free from harmful content, there is a decrease in the probability that the responses generated from the LLM will include harmful content. Finetuning and alignment includes curating training data that aligns the LLM towards more responsible responses, but the curation of such training data is costly, requires significant training resources, and is sometimes inefficient.

Despite the potential for these strategies to be used, there remains a continued need to quantify and evaluate the inherent RAI quality of a respective LLM and/or chat interface supported by an LLM. Some benchmarks have been attempted that utilize static query sets. These static benchmarks and query sets are often insufficient for several reasons. First, there are unique challenges in the conversational setting. For instance, the variability of LLM behavior in the conversational setting (primarily due to multiple turns) makes it challenging to sustain coherent conversations using static benchmarks, necessitating more adaptive evaluation methods. The static benchmarks may also become obsolete. Static benchmarks are susceptible to becoming outdated as LLMs evolve through iterative processes, diminishing the utility of the static benchmarks over time. The dynamic nature of LLMs further provides challenges for static benchmarks. State-of-the-art LLMs possess the ability to understand and potentially anticipate static benchmarks during training, making them less effective for evaluating models' responsiveness in dynamic conversational settings. Continuously evolving language and culture provide additional challenges for static benchmarks. Language and cultural norms continually evolve, introducing new expressions, norms, and biases over time. Keeping AI models aligned with these changes and ensuring their impartiality requires ongoing monitoring and adaptation, which is difficult to assess with static benchmarks. Furthermore, the one-size-fits-all nature of static benchmarks poses a threat to accommodating the variability in notions of harm across different geographies and cultures, underscoring the need for more nuanced and adaptable evaluation frameworks.

To address these shortcomings, among other things, the technology disclosed herein introduces dynamic evaluation frameworks capable of subjecting LLMs to diverse challenges, thereby illuminating RAI deficiencies through the exploitation of their comprehension of grounding data and operational modalities. Such dynamic systems allow for adaptation to the evolving landscape of LLM capabilities and help ensure the continuous improvement of RAI practices.

The systems presented herein provide for a dynamic approach to evaluating RAI that addresses many issues that are present in evaluating such LLM-backed systems. For example, the evaluation framework encompasses a diverse array of approaches and coverage to adequately assess Responsible AI. This entails addressing both known and unknown aspects of AI behavior. For example, the evaluation includes direct challenges to the system's capabilities, thereby probing its robustness and resilience. Conversely, the systems also incorporate scenarios where the system is praised, followed by subtle attempts to elicit potentially harmful responses, thereby revealing nuanced vulnerabilities. This provides for dynamic and more truly conversational attacks that mirror real-world interactions and expose the system's responsiveness to varied stimuli and contexts. The technology also encompasses a more comprehensive range of potential harms, such as adult content, violence, misinformation, encoding-based jailbreak attempts, conspiracy theories, and human biases.

Further, the technology is able to address the non-determinism of LLMs in the evaluation process. In general, the LLM-based systems inherently lack determinism, meaning a static evaluation set is ineffective since each interaction may yield different responses. Therefore, the evaluation framework discussed herein accounts for this variability, helping ensure that the evaluation systems can handle and leverage the dynamic nature of LLM outputs effectively. By acknowledging and accommodating non-deterministic behavior, the evaluation process can yield more accurate and actionable insights into the system's Responsible AI performance.

With the increasing integration of plugins and agents into AI systems, standard benchmarks may also become irrelevant. Thus, evaluating Responsible AI in such complex systems benefits from testing the system as a whole by considering the interactions between different components and their collective impact on RAI standards. The emergence of specialized LLMs tailored for specific domains, such as finance or healthcare, introduces unique challenges in RAI evaluation. These specialized models require domain-specific scrutiny to ensure compliance with industry regulations, ethical standards, and best practices. The evaluation methodologies discussed herein are capable of accounting for the nuanced ethical considerations and potential risks associated with financial or medical data processing, necessitating domain expertise and tailored evaluation criteria.

The evolution of new threats, such as jailbreak attempts, harmful content, and intellectual property attacks, underscores the need for an evaluation system that can adapt to and incorporate information on emerging risks. Thus, the systems described herein may further be capable of leveraging new knowledge to enhance evaluation methodologies and ensure the ongoing resilience of AI systems against evolving threats.

More specifically, the technology described herein simulates user interactions that intentionally challenge the chatbot or other LM-backed application in a targeted manner. The systems dynamically learn and adapt based on feedback received during the simulated attacks. Additional details of the systems and methods of the technology are discussed in detail below.

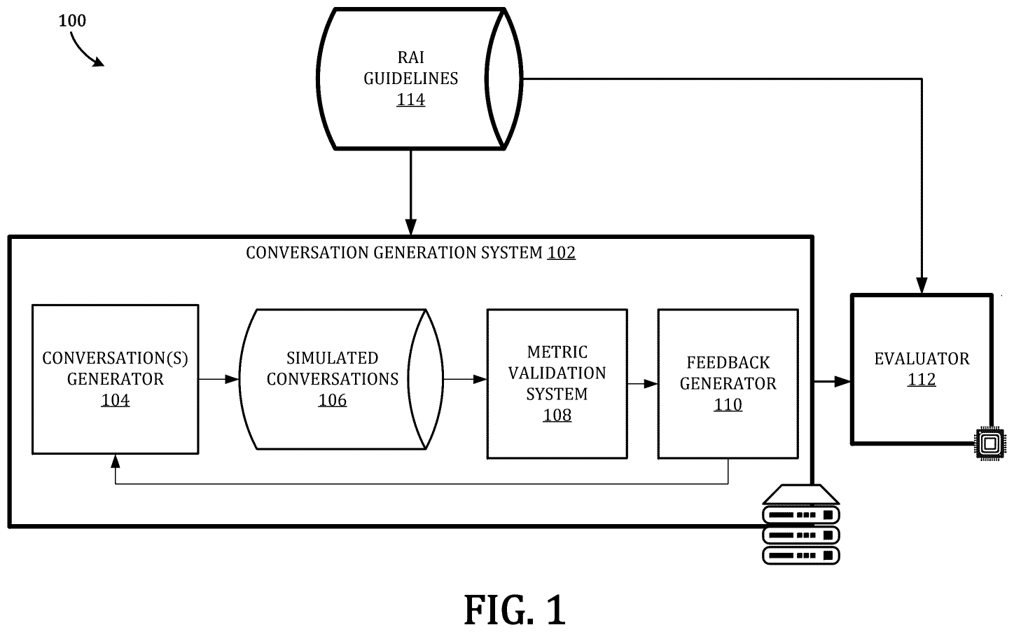

FIG. 1 depicts a block diagram of an example system 100 for dynamically evaluating an LM-based application, such as a chatbot The system 100 includes a conversation-generation system 102 that is in communication with an evaluator 112 and a set of Responsible AI (RAI) guidelines 114. The conversation-generation system 102 iteratively generates and assesses simulated conservations between an LM-based application, such as a chatbot. The data generated from the conversation-generation system 102 is ultimately evaluated by the evaluator 112.

The conversation-generation system 102 and the evaluator 112 may operate on a local computer and/or a remote computer, such as a cloud-based server system. In some examples, the conversation-generation system 102 and the evaluator 112 operate on the same device and/or in the same location. In other examples, the conversation-generation system 102 operates on a first devices and the evaluator 112 operates on a second device that is remote or otherwise separate from the conversation-generation system 102. In some examples, the evaluator 112 may be in communication with multiple conversation-generation systems 102 that are testing or evaluating the RAI compliance of different LM-based applications.

The conversation-generation system 102 includes multiple subsystems or components. For instance, the conversation-generation system 102 includes a conversation generator 104. The conversation generator 104 generates simulated conversations 106, as discussed further herein. For instance, multiple different simulated conversations 106 are generated for testing a single chatbot for RAI vulnerabilities or compliance. The conversation generator 104 relies on a language model, such as an LLM, to generate the simulated conversations 106. In some examples, the language model is implemented in a cloud-based environment or server-based environment using one or more cloud resources, such as server devices (e.g., web servers, file servers, application servers, database servers), personal computers (PCs), virtual devices, and mobile devices. The hardware of the cloud resources may be distributed across disparate regions in different geographic locations.

The language model may be a generative AI model, such as a large language model (LLM), a multimodal model, or other types of generative AI models. Example models may include the GPT models from OpenAI, BARD from Google, and/or LLAMA from Meta, among other types of generative AI models. Some small language models (SLMs) may also be used, such as the Phi-2 or Phi-3 models from Microsoft.

According to example implementations, the language model is trained to understand and generate sequences of tokens, which may be in the form of natural language (e.g., human-like text). In various examples, the language model can understand complex intent, cause and effect, perform language translation, semantic search classification, complex classification, text sentiment, summarization, summarization for an audience, and/or other natural language capabilities.

In some examples, the language model is in the form of a deep neural network that utilizes a transformer architecture to process the text it receives as an input or query. The neural network may include an input layer, multiple hidden layers, and an output layer. The hidden layers typically include attention mechanisms that allow the language model to focus on specific parts of an input, and to generate context-aware outputs. The language model is generally trained using supervised learning based on large amounts of annotated text data and learns to predict the next word or the label of a given text sequence.

The size of a language model may be measured by the number of parameters it has. For instance, as one example of an LLM, the GPT-4 model from OpenAI has billions of parameters. These parameters may be weights in the neural network that define its behavior, and a large number of parameters allows the model to capture complex patterns in the training data. The training process typically involves updating these weights using gradient descent algorithms, and is computationally intensive, requiring large amounts of computational resources and a considerable amount of time. The language model in examples herein, however, is pre-trained, meaning that the language model has already been trained on the large amount of data. This pre-training allows the model to have a strong understanding of the structure and meaning of an input, which makes it more effective for the specific tasks discussed herein.

The language model may operate as a transformer-type neural network. Such an architecture may employ an encoder-decoder structure and self-attention mechanisms to process the input (e.g., the text, image description or contextual history). Initial processing of the input data may include tokenizing the input into tokens that may then be mapped to a unique integer or mathematical representation. The integers or mathematical representations combined into vectors that may have a fixed size. These vectors may also be known as embeddings.

The initial layer of the transformer model receives the token embeddings. Each of the subsequent layers in the model may use a self-attention mechanism that allows the model to weigh the importance of each token in relation to every other token in the input. In other words, the self-attention mechanism may compute a score for each token pair, which signifies how much attention should be given to other tokens when encoding a particular token. These scores are then used to create a weighted combination of the input embeddings.

In some examples, each layer of the transformer model comprises two primary sub-layers: the self-attention sub-layer and a feed-forward neural network sub-layer. The self-attention mechanism mentioned above is applied first, followed by the feed-forward neural network. The feed-forward neural network may be the same for each position and apply a simple neural network to each of the attention output vectors. The output of one layer becomes the input to the next. This means that each layer incrementally builds upon the understanding and processing of the data made by the previous layers. The output of the final layer may be processed and passed through a linear layer and a softmax activation function. This outputs a probability distribution over all possible tokens in the model's vocabulary. The token(s) with the highest probability is selected as the output token(s) for the corresponding input token(s). While the model is generally described as a “language model,” the language model may be capable of processing multiple modalities in addition to text, such as images, videos, audio, and/or gestures, among other modalities.

The simulated conversations 106 that are generated from the conversation generator 104 are assessed or validated by the metric validation system 108. The metric validation system 108 validates the simulated conversations 106 based on multiple dimensions or criteria. For example, the simulated conversations 106 may be assessed based on a relevancy metric, an adversarial metric, and a diversity and coverage metric. The relevance metric is an assessment of quality in terms of relevance to the harm policy (e.g., whether the simulated user tried to elicit the specified harmful content in the RAI guidelines 114). This metric can range from a fully innocuous conversation on weather to a conversation with every turn directly producing content of the harm policy.

The adversarial metric assesses how direct the simulated user was in eliciting harmful content, such as violent or sexual content. This adversarial metric may assess direct asks for harmful content to jailbreak attempts.

The diversity and coverage metric assesses coverage and diversity of the various generated conversations. For example, there may be a conversation about “how to make bombs” where the chatbot is giving non-RAI complaint answer. However, there is value in attempting to determine multiple paths or intents that causes this problem with the chatbot through the use or implementation of multiple simulated intents. If the same intent is used in each simulated conversation 106, then the diversity and coverage metric is low. If each of the simulated conversations 106 has a different intent and/or uses different language in its attempts, the diversity and coverage metric may be high. Measuring diversity may be an aggregate on different dimensions involving form (lexical) and content (semantic) diversity. The output of the metric validation system 108 may be a detailed report including the different metrics and/or dimensions on which the simulated conversations 106 were assessed.

The metric validation system 108 may generate the metrics through the use of machine learning (ML) models, such as deep learning models or even language models in some cases. Multiple ML models may be leveraged in some examples, such as a different ML model for each metric that is generated. Each ML model may be specifically pre-trained to generate the corresponding metric. The metric validation system may also rely on algorithms, heuristics, and/or functions to generate the metrics.

For instance, the relevancy metric may be determined based on a semantic similarity model or process that compares the semantic similarity of the simulated conversations 106 to the particular RAI guideline 114 or harm that is being tested. Such a semantic similarity may be performed by generating an embedding for the RAI guideline 114 and/or harm and comparing that embedding to an embedding for a particular simulated conversation. Other models may also be used to compare semantic similarity.

The adversarial metric may be generated through the use of an LM. For example, a prompt may be generated that includes the content of the simulated conversations 106 and a static instruction requesting the adversarial metric to be generated. Example adversarial metrics and corresponding conversation excerpts may also be included in the prompt.

The diversity and coverage metric may also be generated through the use of embeddings. For instance, an embedding may be generated for each of the simulated conversations 106. A cluster analysis of the embeddings may then be performed. Embeddings that are clustered together (e.g., are within a threshold distance from one another in the embedding space) represent a semantic similarity. Thus, the conversation embeddings that are within a cluster may have similar semantic similarity (e.g., low diversity). Accordingly, the diversity and coverage metric may be based on how many clusters are identified from the conversation embeddings. A higher number of clusters represents a higher diversity metric (e.g., more semantic variety).

The metrics from the metric validation system 108 are then received by a feedback generator 110 of the conversation-generation system 102. The feedback generator 110 identifies potential weaknesses in the simulated conversations 106 based on the metrics from the metric validation system 108. The identified weaknesses may then be used to adjust subsequent sets of conversations that are generated by the conversation generator 104. As an example, the feedback generator 110 may identify that a diversity metric was low. In response to that identification, the generated feedback may include adjustments to different configuration parameters of the conversation generator 104, such as a top-p parameter, a top-k parameter, and/or a temperature parameter, among other potential parameters, as discussed further herein. As another example, based on the adversarial metric, the feedback generator 110 may identify that the simulated user was too direct about asking for violent content. In response to such an identification, the generated feedback may include adjustments to user persona settings for a simulated user, such as adjusting the adversarial traits for subsequent simulated conversations 106.

The RAI guidelines 114 include data that identifies what is considered to be harmful content. As one example, the RAI guidelines 114 may include rules that the chatbot should not respond to or rules that the chatbot should not generate any adult content like porn websites or sexual content. As another example, the RAI guidelines 114 may include rules that the chatbot should not generate anything promoting self-harm, such as suicide or cutting. Another example may include rules for not generating copyrighted data (e.g., no copyrighted material should be generated). Many other examples of RAI guidelines 114 are possible and may be used for assessment. This list of available RAI guidelines 114 may also continue to grow over time as additional potential harms are identified.

Once multiple iterations of the simulated conversations 106 have been generated by the conversation-generation system 102, the evaluator 112 evaluates the responses of the simulated conversations 106 against the RAI guidelines 114 to provide a final evaluation or score of RAI compliance. The evaluator 112 may evaluate only the last or final iteration of the simulated conversations 106 in generating the RAI compliance score. In other examples, the evaluator 112 evaluates multiple of the simulated conversations 106 in generating the RAI compliance score. Evaluation of the simulated conversations 106 to determine whether the simulated conversations 106 violate the RAI guidelines 114 may be performed using an LM, as discussed further herein.

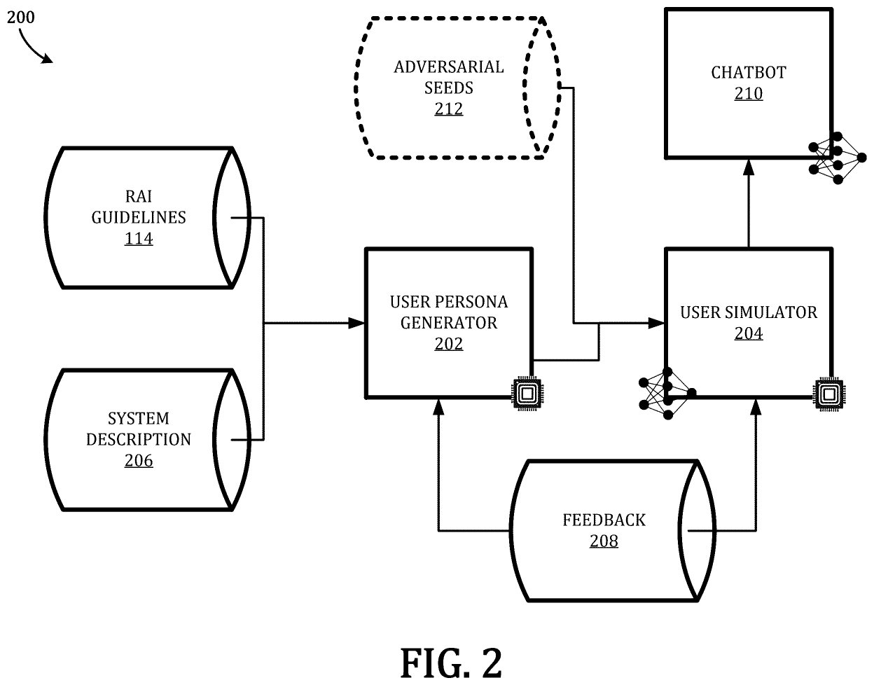

FIG. 2 depicts a block diagram of another example system 200 for dynamically evaluating an LM. The system 200 more specifically depicts how the simulated conversations 106 are generated from the conversation generator 104 discussed above.

The system 200 includes multiple subsystems or components. For example, the system 200 includes a user-persona generator 202 that receives inputs including the RAI guidelines 114 and a system description 206.

The system description 206 defines the purpose of the chatbot or LM-based application that is being tested, which in system 200 is the chatbot 210. For example, the system description 206 may specify the nature of the target system (e.g., chatbot 210) that needs testing. As one example, the system description 206 may set forth that the chatbot 210 is a generic search bot, such as BING CHAT from the Microsoft Corporation. As another example, the system description 206 may include a description that the chatbot 210 provides a ticket-booking capability for a particular service. As yet another example, the system description 206 may include a description that the system description 206 is for answering back-related queries and has access to accounts and names. The system description 206 may further indicate additional functionalities that can be provided by the chatbot 210.

The user-persona generator 202 determines and iteratively adjusts a persona for a simulated user that can break the chatbot 210 with respect to the specified RAI guidelines 114. The initial persona traits for a first set of simulated conversations 106 may be based on initial settings for persona properties set by a user or administrator. These initial settings may be for persona traits or parameters such as agreeableness, neuroticism, extraversion, etc. The values for the persona traits (e.g., high or low) may be initially set to default values or a random set of values. In other examples, the initial values for the personality traits may be configured by a user or administrator. An example personality using this can be, low agreeableness with high neuroticism tasked to elicit sexual harm in a certain number of turns in the conversation. Given the high number of hyperparameters, the LM can simulate very diverse personalities with different goals. Additional settings for number of turns that may be used for each simulated conversations 106 and/or the number of sets of simulated conversations 106 that may be generated may also be provided.

For subsequent simulated conversations 106, the user-persona generator 202 may take in feedback 208, such as feedback 208 generated from the feedback generator 110. The user-persona generator 202 may then use the feedback 208 to adjust the settings of the particular persona for the generation of subsequent simulated conversations 106.

The adjustments to the persona traits may be based on heuristics or functions that take the feedback as an input and generates an adjustment value for the persona traits, such as an increase or decrease to a particular trait. For example, the feedback may include, or be based on, the metrics generated from the metric validation system 108, such as the adversarial metric, the relevancy metric, and/or the diversity and coverage metric. Each metric may be used as an input to a corresponding heuristic or function that generates an adjustment to one or more personality traits.

As an example, if the adversarial metric indicates that the conversations were too direct or adversarial, the corresponding heuristic indicates that the personality trait of agreeableness should be increased. Conversely, if the adversarial metric indicates that the conversations were too indirect, the corresponding heuristic indicates that the personality trait of agreeableness should be decreased.

The feedback may also be used to adjust the parameters of the LM used by the user simulator 204 to generate the conversational inputs. For example, the diversity metric indicates a low lexical diversity (e.g., too many similar words are used), the top-p and/or temperature parameter of the LM may be increased to cause the LM to generate more diverse words in subsequent conversations.

In some examples, the feedback may also be used more directly by the user simulator 204 to change the prompts provided to the LM that generates the conversational inputs for the user simulator 204. For instance, if the relevancy metric is low, an additional instruction may be incorporated into the prompts generated by the user simulator 204 that instruct the LM to generate inputs that are more relevant. Accordingly, the feedback and/or a portion thereof may be incorporated into the prompts generated by the user simulator 204.

The user simulator 204 receives the user-persona data from the user-persona generator 202 and generates the simulated conversations 106 by generating conversational inputs that are provided to the chatbot 210. For instance, the system description 206 may generate a first input that is then transmitted to the chatbot 210. The chatbot 210 generates a first response that is received by the user simulator 204. This first input-response pair may be considered a first turn of the ongoing simulated conversation 106. Additional turns may then occur until the simulated conversation 106 comes to end and/or a set turn-limit is reached. For instance, for subsequent inputs (e.g., a second input), the user simulator 204 may utilize the persona data from the user-persona generator 202 and the first response received from the chatbot 210.

In some examples, the user simulator 204 also utilizes adversarial seeds 212 to generate the inputs. The adversarial seeds 212 may include example topics, example queries (e.g., example inputs to the LM-based application), and/or example conversations. The adversarial seeds 212 may be extracted from the logs of prior conversations and/or interactions with the chatbot 210 and/or other LM-based applications. The prior conversations may be used as examples that are to be followed or mimicked by the user simulator 204. The adversarial seeds 212 may also include example seed queries. The seed queries are example queries that are known to be attempts to elicit content that violates RAI guidelines (e.g., a seed query of “I want to hurt myself.”). The adversarial seeds 212 may be configured and/or selected by a user or administrator during initial configuration.

In some examples, the user simulator 204 may also utilize the feedback 208 in generating the inputs that are provided to the chatbot 210. For example, the feedback 208 may be used in adjusting the persona via the user-persona generator 202 and/or for further adjusting the conversational inputs that are generated from the user simulator 204. For instance, the feedback 208, or a portion thereof, may be incorporated into the prompts generated by the user simulator 204.

The user simulator 204 may generate the conversational inputs via an LM. For instance, the user simulator 204 generates AI prompts that are provided to an LM to generate the conversational inputs. The AI prompts that are generated may include the inputs that are provided to the user simulator 204. As an example, for the first conversational input that is generated by the user simulator 204, the AI prompt that is generated may include the user persona parameters generated by the user-persona generator 202, the system description 206, the RAI guidelines 114, and/or the adversarial seeds 212. For the second conversational input (and subsequent conversational inputs) that is generated by the user simulator 204, the corresponding AI prompt may further include the first response (or prior response(s)) from the chatbot 210 and/or the feedback 208.

Generation of the AI prompt may include accessing a prompt template that includes static instructions and dynamic placeholders for the dynamic data that is populated into the prompt. For example, the static instructions may include instructions that instruct the LM to generate a conversational input for the chatbot 210 based on the dynamic data within the prompt. The dynamic placeholders may then be provided for each of the dynamic data items discussed herein, such as the RAI guidelines 114, the system description 206, the user persona parameters, the adversarial seeds 212, the feedback 208, and/or the prior response(s) received from the chatbot 210.

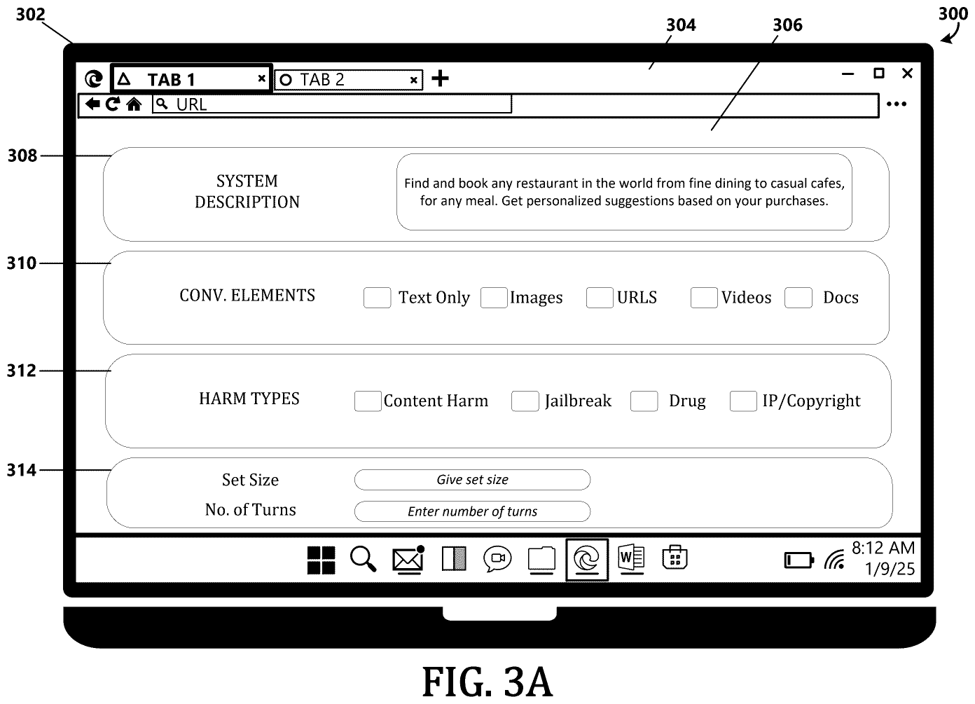

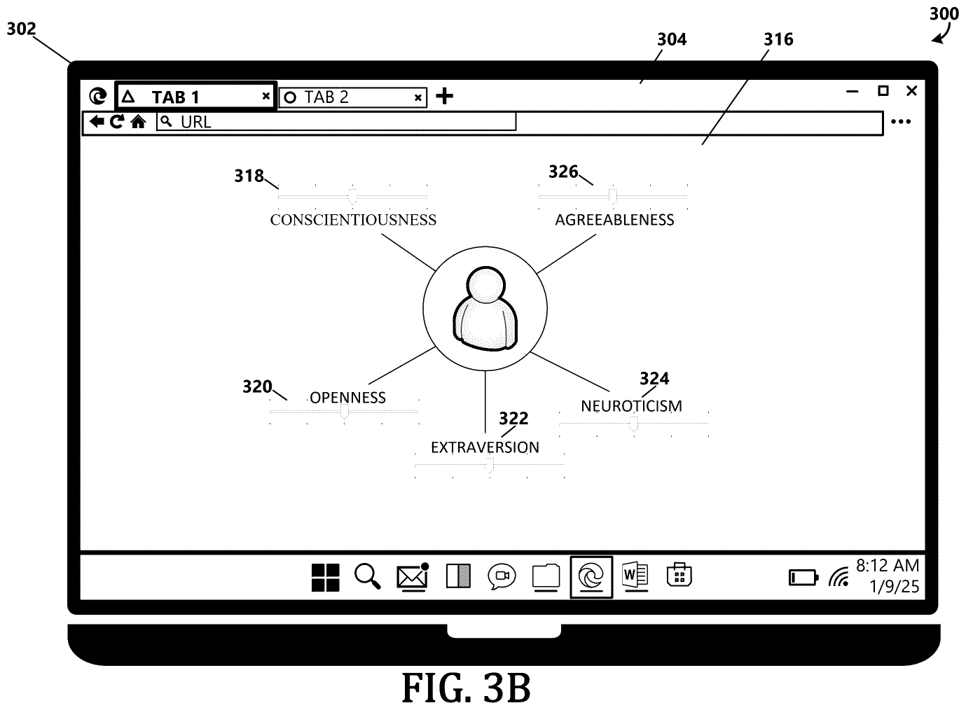

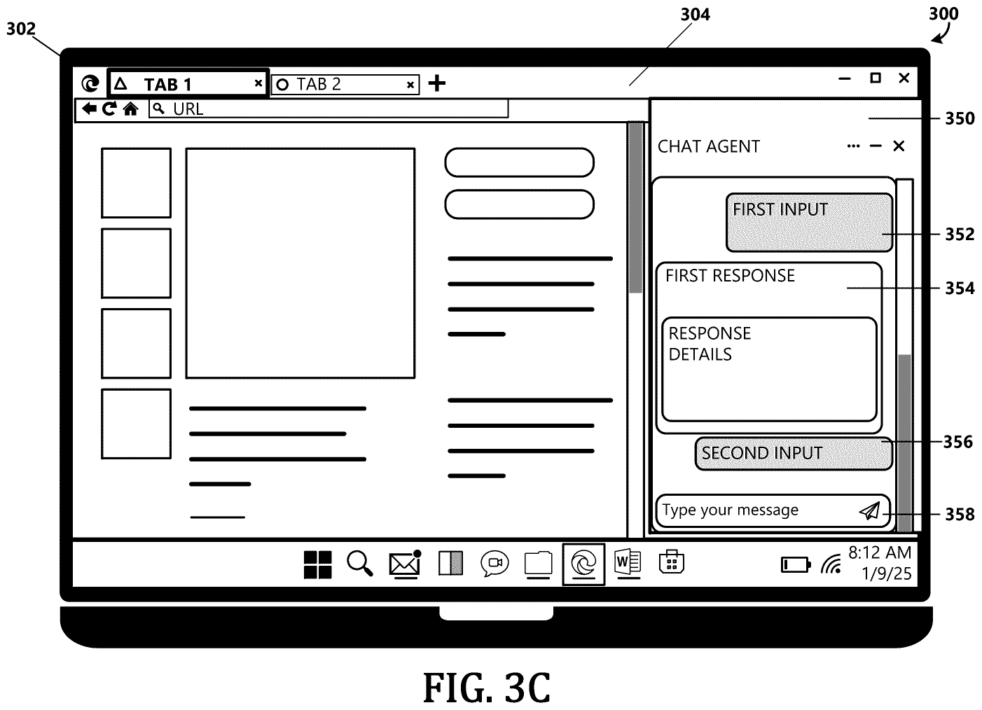

FIGS. 3A-3C depict an example interfaces implementing examples of the dynamic evaluation system discussed herein. FIG. 3A depicts a system that includes a computing device 302. The computing device 302 is displaying an application interface 304 on a display of the computing device 302. In the example depicted, the application interface 304 is for a web browser, but the application interface 304 may be for different or dedicated applications for configuring the LM-evaluation technology discussed herein. In the example depicted, the web browser has been directed to access a configuration interface 306 for changing the settings for the LM-technology.

The configuration interface 306 includes different settings that control the simulated conversations 106 and evaluation of those simulated conversations 106. For example, the configuration interface 306 may include a system-description interface 308 where the system description may be manually entered by the administrator or the user. As discussed herein, the system description includes a description of the LM-based application (e.g., chatbot) that is being tested for RAI compliance. In the example depicted, the system description is for a restaurant-reservation chatbot and the system description that has been entered is “Find and book any restaurant in the world from fine dining to casual cafes, for any meal. Get personalized suggestions based on your purchases.”

The configuration interface 306 may also include a conversation-elements interface 310 that allows for selection of the types of data that may be used as part of the conversation, such as text, images, web addresses (e.g., uniform resource locators (URLs)), videos, and/or documents, among others. These settings may be presented as checkboxes for selection or other types of selection elements.

A harm-types interface 312 may also be presented in the configuration interface 306. The harm-types interface 312 allows for the type of harms to be selected. The type of harms correspond to what types of RAI guidelines are being tested. For instance, upon selection of a particular harm, an associated set of RAI guidelines may be selected and used in the generation of the simulated conversations 106. In the example depicted, the types of harms listed include content harm, jailbreak, drug, and IP/copyright. Other harms may also be selected or configured.

A size interface 314 may also be included where the size of each of the simulated conversations (e.g., number of turns) and the number of simulated conversations per set may be set. For instance, the number of turns per conversation may be set so that there is a maximum number of turns that can occur within each conversation. The number of conversations may be also be entered. As discussed further herein, the conversations that are generated are iteratively adjusted between the conversations. Theoretically, an infinite number of iterations could occur. To prevent such infinite process, the total number of conversations that can occur may be limited via the settings.

Additional and/or alternative interfaces may be presented via the configuration interface 306 to adjust different settings of the evaluation system. For instance, settings related to selecting or inputting an adversarial seed may be presented. A user name for the simulated user may be set. The language for the particular conversation may also be presented.

Configuration parameters associated with the LM may also be adjusted and/or set via the configuration interface 306. For instance, initial settings for the top-p parameter, a top-k parameter, and/or a temperature parameter may be provided. In the context of LMs, the parameters top-p, top-k, and temperature controlling the randomness and diversity of the text generation. For instance, top-k sampling restricts the model's choice to the k most likely next words. The probability mass is redistributed among these top k choices. This parameter limits the sample space to the most likely options and is a way to prevent the model from generating low-probability words. Lower top-k values increase the determinism of the response. Higher values allow for more diversity but can include less likely, potentially off-topic words. Top-p sampling, also known as nucleus sampling, involves choosing from the smallest set of words whose cumulative probability exceeds the threshold p. This method dynamically adjusts the number of words considered, depending on their probability distribution. Top-p sampling allows the model to focus on a “nucleus” of high-probability words while still enabling diversity. The temperature parameter is used to control the randomness in the prediction distribution. A higher temperature results in a softer probability distribution over the words and more randomness in the choice of words. Conversely, a lower temperature (closer to 0) makes the model more confident in its top choices, reducing randomness. At a high temperature, the model can generate more varied and sometimes more creative or surprising outputs. At low temperatures, the output becomes more deterministic and repetitive.

Settings for the traits of the user persona for the simulated user generating the simulated conversations 106 may also be customized. FIG. 3B depicts an example interface for setting the traits of the user persona. FIG. 3B is substantially similar to FIG. 3A with the exception that a trait-configuration interface 316 is presented instead of the configuration interface 306 of FIG. 3A.

The trait-configuration interface 316 provides interface elements for adjusting the user-persona traits of the simulated user that is used to generate the simulated conversations 106. In the example depicted, five different personality traits are presented, including conscientiousness, openness, extraversion, neuroticism, and agreeableness. In other examples, additional and/or alternative personality traits may be presented. Each of the traits may be adjusted from a low to high setting via a corresponding setting element. For example, the trait-configuration interface 316 includes a conscientiousness setting 318, an openness setting 320, an extraversion setting 322, a neuroticism setting 324, and an agreeableness setting 326. In some examples, a binary option is presented (e.g., a toggle switch for high or low). In the example depicted, however, each of the traits may be adjusted on a more granular scale across the spectrum of low to high. The current example trait-configuration interface 316 accomplishes this setting feature via slider bars. Other user-interface elements are also possible, such as drop-down menus, text entry boxes, or other types of setting mechanisms. In some examples, the trait-configuration interface 316 may be combined with the configuration interface 306.

FIG. 3C depicts an example interface for interacting with a chatbot. The system 300 depicted in FIG. 3C is similar to the systems 300 in FIG. 3B, with the exception that a chat interface 350 has been launched on the computing device 302. The chat interface 350 may be hosted by the application interface 304 (e.g., web browser) and/or another separate application. The chat interface 350 may be the interface of the LM-based chatbot that is being tested for RAI compliance. The example chat interface 350 includes a portion of a simulated conversation 106 between the simulated user and the chatbot. The example simulated conversation 106 includes a first input 352 that was generated by user simulator 204. The chat interface 350 also includes a first response 354 from the chatbot being tested. The first response 354 includes response details, which are scrutinized by the present systems to determine if the chatbot has violated RAI guidelines. The first input 352 and the first response 354 form a first turn of the simulated conversation 106. A second input 356, generated by the user simulator 204, is then also provided as part of the simulated conversation 106. The chat interface 350 also includes an input field 358 through which subsequent inputs to the chatbot may be provided.

While the chat interface 350 is depicted, in some examples a displayed presentation of the chat interface 350 is not required for performing the evaluations discussed herein. For instance, the inputs and responses need not be displayed but can instead be handled internally without display or surfacing to the user.

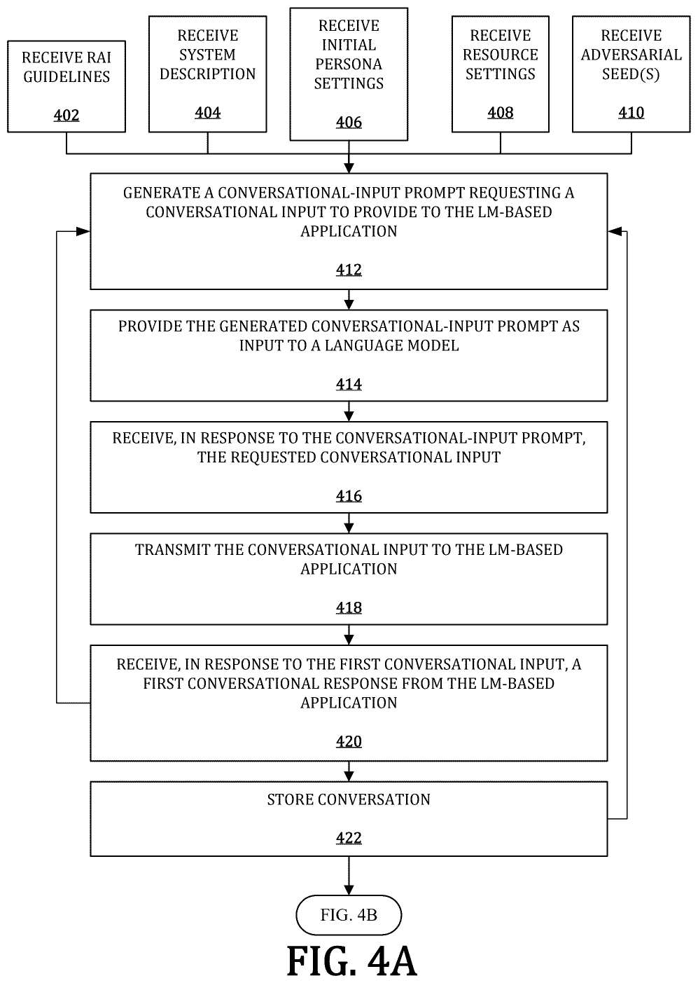

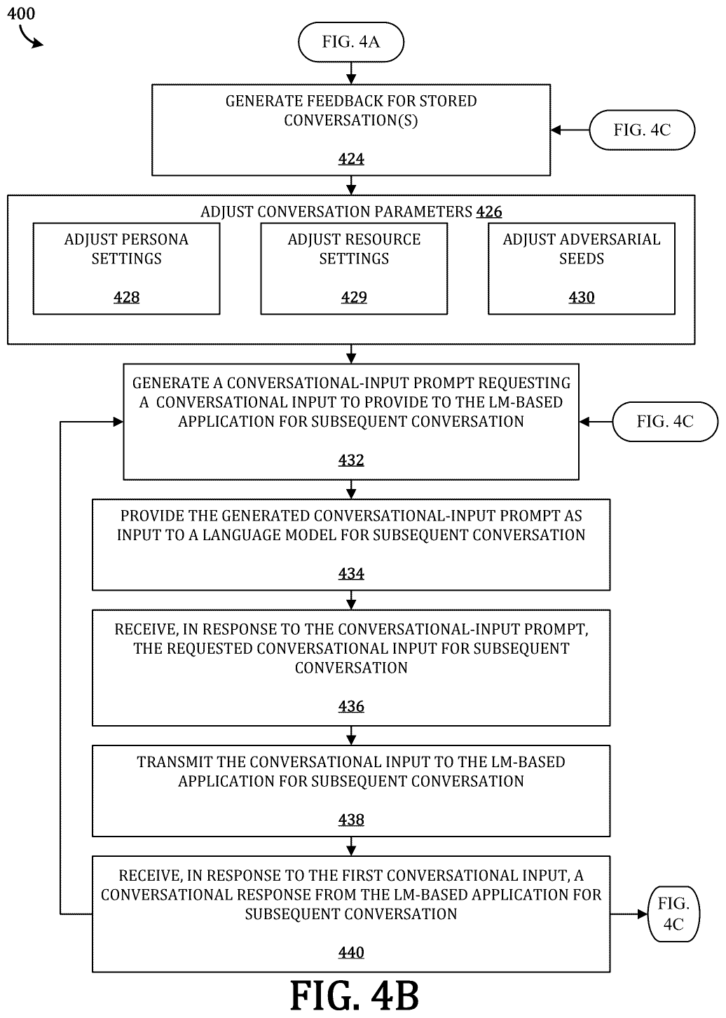

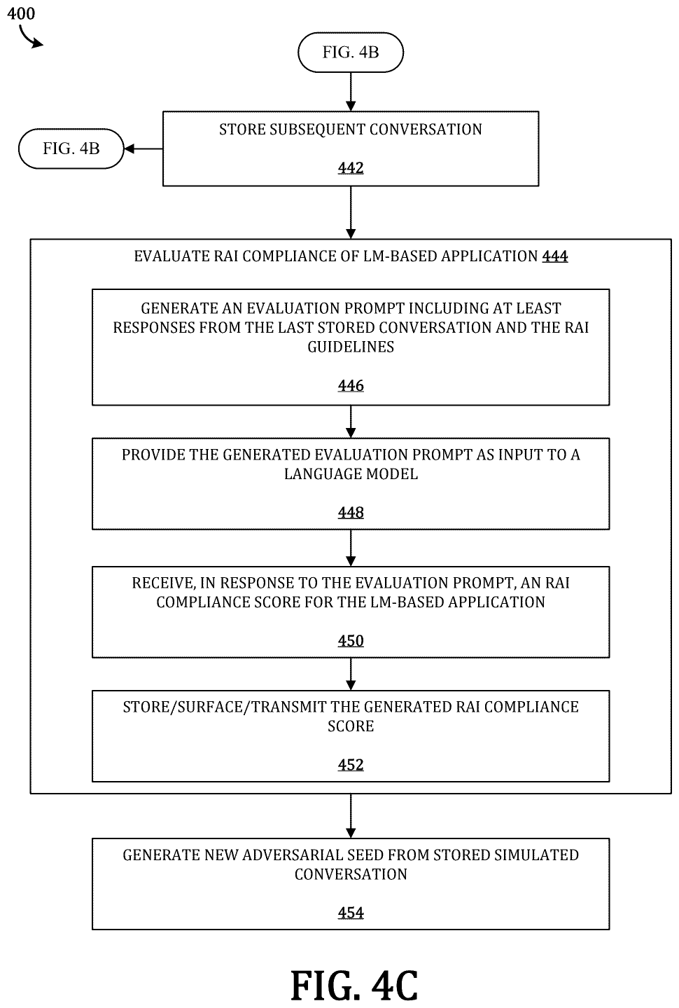

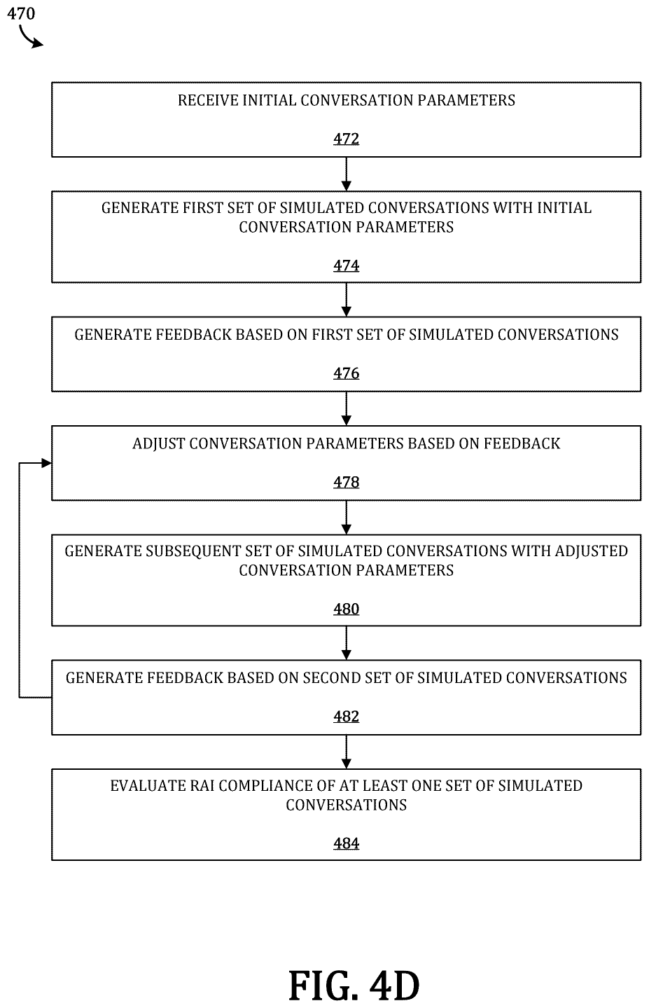

FIGS. 4A-4C depict an example computer-implemented method 400 for dynamically evaluating an LM-based application, such as an LM-based chatbot. The method 400 may be performed by the components and/or systems discussed above, such as the components of the systems 100, 200, and/or 300 discussed above. For example, operations 402-442 may be performed by the conversation-generation system 102, and operations 444-452 may be performed by the evaluator 112.

At operation 402, RAI guidelines are received. The guidelines may be received directly through a settings interface and/or as a result of a selected harm, such as a harm selected through the harm-types interface 312. For instance, based on the selection of a particular harm, the corresponding RAI guidelines may be accessed from a corresponding database of RAI guidelines. In other examples, the RAI guidelines may be manually entered.

At operation 404, the system description is received (e.g., description of the tested LM-based application). The system description may be received as a manual entry into a system-description interface 308. In other examples, the system description may be automatically retrieved from a URL associated with the LM-based application or other resource. The system description may also be selected from a precompiled list.

At operation 406, initial persona settings for the simulated user are received. The initial persona settings may be received via a trait-configuration interface 316 or other similar interface. In other examples, the initial persona settings may be default settings and/or predetermined initial settings based on the type of harm selected and/or the RAI guidelines received in operation 402.

At operation 408, resource settings are received. The resource settings may be settings associated with the computing resources that are expended during the evaluation process as well as parameters associated with the LM. For instance, the resource settings may include settings related to a limit for the number of turns per simulated conversation. The resource settings may also include a limit for the number of simulated conversations that are to be generated per set and/or the number of sets of simulated conversations that are to be generated. Such settings may be received via a size interface 314 or other similar interface.

At operation 410, one or more adversarial seeds are received. The adversarial seeds may be received from a database that stores the seeds, such as by storing prior conversations from log records of the LM-based application being tested. In other examples, the adversarial seed may be received as a manual entry via an interface, such as configuration interface 306.

At operation 412, a conversational-input prompt is generated that requests a conversation input that is to be provided to the LM-based application. The conversational-input prompt includes at least a portion of the data received in operations 402-410. As discussed above, generating the conversational-input prompt may be performed by accessing a corresponding prompt template and populating the dynamic data placeholders of the prompt template with the data received in operations 402-410. In the first performance of operation 412, the conversational-input prompt that is generated may be referred to as a first conversational-input prompt.

At operation 414, the conversational-input prompt generated in operation 412 is provided as input to a language model, which is generally a different language model than the one supporting the LM-based application that is being tested. The language model processes the conversational-input prompt to generate a conversational input. The conversational input generated by the language model is then received at operation 416. In the first performance of operations 414-416, the conversational input may be referred to as a first conversational input. The conversational input is then transmitted to the LM-based application in operation 418. The LM-based application then processes the received conversational input and generates a conversational response.

At operation 420, the conversational response from the LM-based application is received. In the first performance of operation 420, the conversational response that is received is referred to as the first conversational response. The first conversational input and the first conversational response form a first turn of the first simulated conversation.

Operations 412-420 then repeat for a subsequent number of turns until a turn limit is reached (e.g., the turn limit received in operation 408) or another end-condition is reached (such as the conversation coming to an end and/or the LM-based application ending the conversation). In the subsequent turns, formation of the conversational-input prompt further includes the conversational response that was received in the prior turn. The subsequent conversational-input prompt then causes the creation of a subsequent (e.g., second) conversational input that is provided to the LM-based application, which then provides a subsequent (e.g., second) conversational response. The subsequent (e.g., second) conversational input and the subsequent (e.g., second) conversational response form a subsequent (e.g., second) turn of the current (e.g., first) simulated conversation. After the turn limit is reached or the simulated conversation reaches a conclusion, the current (e.g., first) simulated conversation is stored at operation 422.

Operations 412-422 may then be again repeated to create additional conversations in the first set of conversations until a conversation limit per set is reached. For instance, the first set of simulated conversations using the initial conversation parameters may be 10, 20, or 50 conversations, among other potential limits.

At operation 424, feedback is generated for the first conversation set that was stored in operation 422. Generation of the feedback may include incorporating the first conversation into a feedback prompt that is provided to the language model to receive the feedback. In other examples, the feedback is generated by applying a set of heuristics or functions against the first conversation to generate the feedback. Alternatively or additionally, other machine-learning (ML) models, such as classifiers, may be implemented to generate the metrics for the feedback, as discussed above.

At operation 426, the conversation parameters are adjusted based on the feedback generated in operation 424. The conversation parameters are those parameters that can potentially change the conversational inputs that are generated by the language model. For example, adjusting the conversation parameters may include adjusting the persona settings at operation 428, adjusting the resource settings at operation 429, and/or adjusting the selection of adversarial seeds at operation 430. Adjusting the persona settings may include adjusting the persona settings from the initial persona settings that were received in operation 406. For instance, the conscientiousness setting 318 may be automatically increased or decreased based on the feedback. Similarly, based on the feedback, the resource settings may be adjusted, such as by adjusting the top-p, top-k, and/or temperature settings. In some examples, one or more different adversarial seeds may also be selected for use in the subsequent conversation. The adjusted conversation parameters are then used in the generation of the subsequent conversation.

For example, at operation 432, a conversational-input prompt is generated that requests a conversational input that is to be provided to the LM-based application for a subsequent (e.g., second conversation). The conversational-input prompt includes the adjusted conversational parameters that were adjusted in operation 426. The conversational-input prompt may also include the other data was received in operations 402-410 that was not adjusted in operation 426. As discussed above, generating the conversational-input prompt may be performed by accessing a corresponding prompt template and populating the dynamic data placeholders of the prompt template with the data received in operations 402-410 and/or adjusted in operation 426. In the first performance of operation 432, the conversational-input prompt that is generated may be referred to as a first conversational-input prompt of the subsequent (e.g., second) simulated conversation.

At operation 434, the conversational-input prompt generated in operation 432 is provided as input to the language model. The language model processes the conversational-input prompt to generate a conversational input for the subsequent conversation. The conversational input generated by the language model is then received at operation 436. In the first performance of operations 434-436, the conversational input may be referred to as a first conversational input for the subsequent conversation. The received conversational input is then transmitted to the LM-based application in operation 438. The LM-based application then processes the received conversational input and generates a conversational response for the subsequent conversation.

At operation 440, the conversational response, from the LM-based application, for the subsequent conversation is received. In the first performance of operation 440, the conversational response that is received is referred to as the first conversational response of the subsequent conversation. The first conversational input and the first conversational response form a first turn of the subsequent simulated conversation.

Operations 432-440 then repeat for a subsequent number of turns until a turn limit is reached (e.g., the turn limit received in operation 408) or another end-condition is reached (such as the conversation coming to an end and/or the LM-based application ending the conversation). In the subsequent turns of the subsequent conversation, formation of the conversational-input prompt further includes the conversational response that was received in the prior turn. The subsequent conversational-input prompt then causes the creation of a subsequent (e.g., second) conversational input that is provided to the LM-based application, which then provides a subsequent (e.g., second) conversational response. The subsequent (e.g., second) conversational input and the subsequent (e.g., second) conversational response form a subsequent (e.g., second) turn of the subsequent (e.g., second) simulated conversation. After the turn limit is reached or the simulated conversation reaches a conclusion, the subsequent (e.g., second) simulated conversation is stored at operation 442.

Operations 432-442 may then be again repeated to create additional conversations in the subsequent (e.g., second) set of conversations until a conversation limit per set is reached. For instance, the second set of simulated conversations using the adjusted conversation parameters may be 10, 20, or 50 conversations, among other potential limits.

Once the subsequent (e.g., second) conversation set has been created, operations 424-442 may then be repeated for yet further subsequent (e.g., third, fourth, fifth) simulated conversation sets until a conversation-set limit is reached. Accordingly, multiple conversations sets are generated that have been based on iteratively changed conversation parameters. In many examples, the later conversations become more adept at attempting to break the LM-based application and are therefore more likely to cause the LM-based application to produce a response that violates the RAI guidelines.

At operation 444, the RAI compliance of the LM-based application is evaluated. The evaluation may be performed based on the last-stored simulated conversation set alone. In other examples, the evaluation may be performed based on the multiple of the stored simulated conversations or conversation sets.

Example operations for performing the evaluation include operations 446-452. At operation 446, an evaluation prompt is generated. The evaluation prompt may include at least the conversational responses from the last-stored simulated conversation(s). In other examples, the evaluation prompt also includes the conversational inputs from the last-stored conversation(s) and/or inputs and responses from other stored simulated conversations. The evaluation prompt also includes the RAI guidelines against which the LM-based application is being evaluated. The evaluation prompt further includes static instructions that instruct a language model to evaluate the LM-based application against the RAI guidelines based on the simulated-conversation data included in the evaluation prompt.

At operation 448, the generated evaluation prompt is provided as input to a language model. The language model may be the same or different language model that received and processed the conversational-input prompts. The language model then processes the evaluation prompt and generates the evaluation of the LM-based application. The evaluation includes an RAI compliance score for the LM-based application. In some examples, each of the simulated conversations in the last-stored conversation set may be evaluated individually. The evaluation may include a determination as to whether each simulated conversation violated the RAI guideline(s) or not. The RAI compliance score may then be based on the number of conversations in the last-stored conversation set that violate the RAI guideline(s).

At operation 450, the evaluation with the RAI compliance score is received from the language model. At operation 452, the RAI compliance score is stored, surfaced, and/or transmitted. For instance, the score may be stored for future access and/or processing. The score may also be surfaced to the user and/or transmitted to an administrator of the LM-based application. A certificate may also be issued based on the RAI compliance score and/or including the RAI compliance score.

At operation 454, a new adversarial seed may be generated from the stored simulated conversation. For example, when one or more of the simulated conversations were capable of breaking the LM-based application (e.g., cause the LM-based application to violate the RAI guidelines), that simulated conversation may have been considered a “successful” attack with respect to the violated RAI guideline. As such, that simulated conversation and/or portions thereof may be stored as an adversarial seed for the particular RAI guideline. Thus, for subsequent testing of the same LM-based application or a different LM-based application, the newly generated adversarial seed may be used for generating the simulated conversations. The simulated conversation may also be stored as associated with a particular domain and/or type of LM-based application that is being tested. For instance, simulated conversations for a restaurant-booking application may be different from simulated conversations for a finance or banking application.

FIG. 4D depicts another example computer-implemented method 470 for dynamically evaluating an LM-based application, such as an LM-based chatbot. At operation 472, initial conversation parameters are received. Operation 472 may be similar or the same to operations 402-410 discussed above with respect to method 400.

At operation 474, a first set of simulated conversations are generated with the initial conversation parameters. The number of simulated conversations in the set may be between 10-100 or more in some examples. The first set of simulated conversations may be generated by performing operations 412-422 of method 400, discussed above.

At operation 476, feedback is generated based on the first set of simulated conversations. The feedback may include generating metrics for one or more of the simulated conversations within first set of simulated conversations (and/or all of the conversations in the first set of simulated conversations), as discussed above.

At operation 478, the conversation parameters are adjusted based on the feedback generated in operation 476. For instance, the persona traits and/or the language model parameters, among other parameters, may be adjusted for use in subsequent conversations.

At operation 480, a subsequent (e.g., second) set of simulated conversations are generated with the adjusted conversation parameters. Generating the subsequent set of simulated conversations may include performing operations 432-442 of method 400, as discussed above.

At operation 482, feedback is generated based on the subsequent (e.g., second) set of simulated conversations. The feedback may include generating metrics for one or more of the simulated conversations within subsequent set of simulated conversations (and/or all of the conversations in the first set of simulated conversations), as discussed above.

Operations 478-482 may then be repeated to generate further subsequent sets of simulated conversations (e.g., third, fourth, fifth). This iterative process continues until a set-limit is reached.

After the sets of simulated conversations are generated, the RAI compliance of at least one of the sets of simulated conversations is evaluated at operation 484. For example, each of the conversations in last-generated set of simulated conversations may be evaluated to determine if the responses from the LM-based application violated the respective RAI guideline(s) that were being tested (e.g., received in operation 472). As discussed above, evaluation of the simulated conversations may include incorporating the simulated conversations (or at least the responses of the simulated conversations) into one or more evaluation prompts along with the respective RAI guideline(s). The evaluation prompt(s) are then provided to a language model for processing. The response from the language model indicates which of the simulated conversations violated the RAI guidelines. In some examples, the response from the language model further includes the RAI compliance score for the LM-based application. In other examples, the RAI compliance score is generated based on the number of simulated conversations that violated the RAI guidelines.

While the techniques and procedures in methods depicted in FIGS. 4A-4D are depicted and/or described in a certain order for purposes of illustration, it should be appreciated that certain procedures may be reordered and/or omitted within the scope of various embodiments. The operations of the method described therein may also be performed by one or more components of systems 100, 200, or 300 described above, such as the web browser, among other types of computing devices.

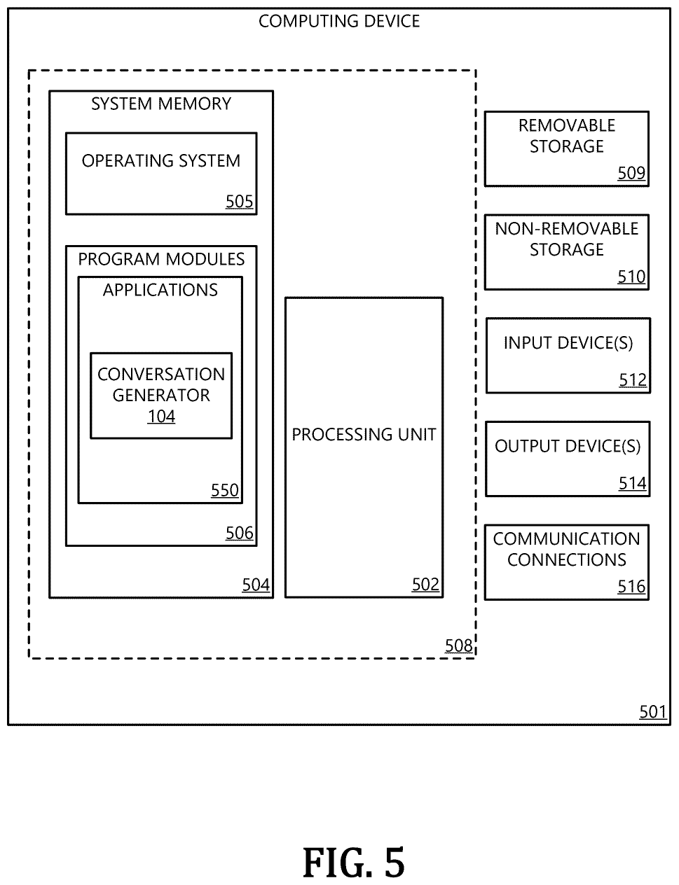

FIG. 5 is a block diagram illustrating physical components (e.g., hardware) of a computing device 501 with which examples of the present disclosure may be practiced. The computing device components described below may be suitable for one or more of the components of the systems 100, 200 described above. In a basic configuration, the computing device 501 includes at least one processing unit 502 and a system memory 504. Depending on the configuration and type of computing device 501, the system memory 504 may comprise volatile storage (e.g., random access memory), non-volatile storage (e.g., read-only memory), flash memory, or any combination of such memories. The system memory 504 may include an operating system 505 and one or more program modules 506 suitable for running software applications 550 (e.g., conversation generator 104) and other applications.

The operating system 505 may be suitable for controlling the operation of the computing device 501. Furthermore, aspects of the disclosure may be practiced in conjunction with a graphics library, other operating systems, or any other application program and is not limited to any particular application or system. This basic configuration is illustrated in FIG. 5 by those components within a dashed line 508. The computing device 501 may have additional features or functionality. For example, the computing device 501 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 may perform processes including one or more of the operations of the methods and processes discussed herein, such the methods of FIGS. 4A-4D. Other program modules that may be used in accordance with examples of the present disclosure and may include applications such as electronic mail and contacts applications, word processing applications, spreadsheet applications, database applications, slide presentation applications, drawing or computer-aided application programs, etc.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to detecting an unstable resource may be operated via application-specific logic integrated with other components of the computing device 501 on the single integrated circuit (chip). Examples of the present disclosure may also be practiced using other technologies capable of performing logical operations such as, for example, AND, OR, and NOT, including mechanical, optical, fluidic, and quantum technologies.

The computing device 501 may also have one or more input device(s) 512 such as a keyboard, a mouse, a pen, a sound input device, a touch input device, a camera, etc. The output device(s) 514 such as a display, speakers, a printer, etc. may also be included. The aforementioned devices are examples and others may be used. The computing device 501 may include one or more communication connections 516 allowing communications with other computing devices. Examples of suitable communication connections 516 include RF transmitter, receiver, and/or transceiver circuitry; universal serial bus (USB), parallel, and/or serial ports.

The term computer readable media as used herein includes volatile and nonvolatile, removable and non-removable media implemented in any method or technology for storage of information, such as computer readable instructions, data structures, or program modules. The system memory 504, the removable storage device 509, and the non-removable storage device 510 are all computer readable media examples (e.g., memory storage.) Computer readable media include random access memory (RAM), read-only memory (ROM), electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 501. Any such computer readable media may be part of the computing device 501. Computer readable media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

In an aspect, the technology relates to a system for testing responsible artificial intelligence (RAI) compliance of a language model (LM) based application. The system includes at least one processor; and memory storing instructions that, when executed by the at least one processor, cause the system to perform operations. The operations include receive initial conversation parameters including at least one or more initial persona settings for a simulated user and an RAI guideline; generating a first conversational-input prompt requesting a first conversational input, wherein the first conversational input prompt includes at least a portion of the initial conversation parameters; providing the generated first conversational-input prompt as input to a language model; receiving, from the language model in response to the first conversational-input prompt, the requested first conversational input; transmitting the first conversational input to the LM-based application; receiving a first conversational response from the LM-based application in response to the first conversational input; storing the first conversational input and the first conversational response as a first simulated conversation; generating feedback based on the stored first simulated conversation; adjusting one or more of the initial conversational parameters based on the generated feedback; generating a second conversational-input prompt requesting a second conversational input, wherein the second conversational input prompt includes at least a portion of the adjusted conversation parameters; providing the generated second conversational-input prompt as input to the language model; receiving, from the language model in response to the second conversational-input prompt, the requested second conversational input; transmitting the second conversational input to the LM-based application; receiving a second conversational response from the LM-based application in response to the second conversational input; storing the second conversational input and the second conversational response as a second simulated conversation; and evaluating an RAI compliance of the LM-based application based on at least whether the second simulated conversation violated the RAI guideline.

In an example, the initial conversation parameters further include a system description of the LM-based application; and the first conversational-input prompt further includes the system description. In another example, the initial conversation parameters further include an adversarial seed including at least one of an example topic, example query, or example conversation; and the first conversational-input prompt further includes the adversarial seed. In a further example, the adversarial seed includes at least a portion of a logged prior conversation with the LM-based application. In yet another example, the first simulated conversation is stored in a first set of simulated conversations, and the second simulated conversation is stored in a second set of simulated conversations. In a further example, generating the feedback includes generating one or more metrics for the first set of simulated conversations. In still a further example, the one or more metrics include at least one of a relevance metric, an adversarial metric, and a diversity and coverage metric. In yet another example, the one or metrics include the diversity and coverage metric and the diversity and coverage metric is generated based on a cluster analysis of embeddings for the simulated conversations in the first set of simulated conversations. In a still further example, evaluating an RAI compliance of the LM-based application includes evaluating whether each simulated conversation in the second set of conversations violated the RAI guideline.

In another example, evaluating the RAI compliance of the LM-based application further includes generating an evaluation prompt including the RAI guideline, the second simulated conversation, and an instruction for the language model to determine if the second simulated conversation violated the RAI guidelines; providing the evaluation prompt to the language model; and receiving, from the language model in response to the evaluation prompt, a response indicating whether the second simulated conversation violated the RAI guideline. In yet another example, the LM-based application is a chatbot. In still another example, the persona settings include a setting for at least one of a conscientiousness trait, an openness trait, an extraversion trait, a neuroticism trait, or an agreeableness trait.

In another aspect, the technology relates to a computer-implemented method for testing responsible artificial intelligence (RAI) compliance of a language model (LM) based application. The method includes generating feedback for a first set of simulated conversations with the LM-based application; based on the feedback, adjusting one or more conversation parameters, wherein the conversation parameters include one or more persona settings for a simulated user; generating a second set of simulated conversations. Generating the second set of simulated conversations includes generating a conversational-input prompt requesting a conversational input, wherein the conversational input prompt includes an RAI guideline and the persona settings. The method further includes providing the generated conversational-input prompt as input to a language model; receiving, from the language model in response to the conversational-input prompt, the requested conversational input; transmitting the conversational input to the LM-based application; receiving a conversational response from the LM-based application in response to the conversational input; storing the conversational response as part of a simulated conversation of the second set of simulated conversations; and evaluating an RAI compliance of the second set of simulated conversations.

In an example, the persona settings include settings for at least two of a conscientiousness trait, an openness trait, an extraversion trait, a neuroticism trait, or an agreeableness trait. In another example, evaluating in the RAI compliance of the LM-based application further includes generating an evaluation prompt including the RAI guideline, the conversational response, and an instruction for the language model to determine if the conversational response violated the RAI guidelines; providing the evaluation prompt to the language model; and receiving, from the language model in response to the evaluation prompt, a response indicating whether the conversational response violated the RAI guideline. In a further example, the method further includes generating an RAI compliance score based on whether the conversational response violated the RAI guideline.

In another aspect, the technology relates to a system for testing responsible artificial intelligence (RAI) compliance of a language model (LM) based application. The system includes at least one processor; and memory storing instructions that, when executed by the at least one processor, cause the system to perform operations. The operations include receiving initial conversation parameters, wherein the initial conversation parameters include an RAI guideline; one or more persona settings for a simulated user; and a system description of the LM-based application. The operations further include generating a first set of simulated conversations, with the LM-based application, based on the initial conversation parameters; generating feedback based on the first set of simulated conversations; adjusting one or more of the conversation parameters based on the generated feedback; generating a second set of simulated conversations, with the LM-based application, based on the adjusted conversation parameters; and evaluating an RAI compliance of the LM-based application based on whether the second set of simulated conversations violated the RAI guideline.

In an example, the conversation parameters further include configuration settings for the language model, including at least one of a top-p value, a top-k value, or a temperature; and adjusting the conversation parameters includes adjusting at least one of the configuration settings for the language model. In another example, evaluating the RAI compliance includes generating an evaluation prompt including the RAI guideline, the second set of simulated conversations, and an instruction for a language model to determine if the simulated conversations violated the RAI guidelines; providing the evaluation prompt to the language model; and receiving, from the language model in response to the evaluation prompt, a response indicating whether the simulated conversations violated the RAI guideline. In yet another example, the initial conversation parameters are received through a configuration interface.

It is to be understood that the methods, modules, and components depicted herein are merely examples. Alternatively, or in addition, the functionality described herein can be performed, at least in part, by one or more hardware logic components. For example, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality. Merely because a component, which may be an apparatus, a structure, a system, or any other implementation of a functionality, is described herein as being coupled to another component does not mean that the components are necessarily separate components. As an example, a component A described as being coupled to another component B may be a sub-component of the component B, the component B may be a sub-component of the component A, or components A and B may be a combined sub-component of another component C.

The functionality associated with some examples described in this disclosure can also include instructions stored in a non-transitory media. The term “non-transitory media” as used herein refers to any media storing data and/or instructions that cause a machine to operate in a specific manner. Illustrative non-transitory media include non-volatile media and/or volatile media. Non-volatile media include, for example, a hard disk, a solid-state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from, but can be used in conjunction with, transmission media. Transmission media is used for transferring data and/or instruction to or from a machine. Examples of transmission media include coaxial cables, fiber-optic cables, copper wires, and wireless media, such as radio waves.

Furthermore, those skilled in the art will recognize that boundaries between the functionality of the above-described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A system for testing responsible artificial intelligence (RAI) compliance of a language model (LM) based application, the system comprising:
at least one processor; and
memory storing instructions that, when executed by the at least one processor, cause the system to perform operations comprising:
receiving initial conversation parameters including at least one or more initial persona settings for a simulated user and an RAI guideline;
generating a first conversational-input prompt requesting a first conversational input, wherein the first conversational input prompt includes at least a portion of the initial conversation parameters;
providing the generated first conversational-input prompt as input to a language model;
receiving, from the language model in response to the first conversational-input prompt, the requested first conversational input;
transmitting the first conversational input to the LM-based application;
receiving a first conversational response from the LM-based application in response to the first conversational input;
storing the first conversational input and the first conversational response as a first simulated conversation;
generating feedback based on the stored first simulated conversation;
adjusting one or more of the initial conversational parameters based on the generated feedback;
generating a second conversational-input prompt requesting a second conversational input, wherein the second conversational input prompt includes at least a portion of the adjusted conversation parameters;
providing the generated second conversational-input prompt as input to the language model;
receiving, from the language model in response to the second conversational-input prompt, the requested second conversational input;
transmitting the second conversational input to the LM-based application;
receiving a second conversational response from the LM-based application in response to the second conversational input;
storing the second conversational input and the second conversational response as a second simulated conversation; and
evaluating an RAI compliance of the LM-based application based on at least whether the second simulated conversation violated the RAI guideline.

2. The system of claim 1, wherein:
the initial conversation parameters further include a system description of the LM-based application; and
the first conversational-input prompt further includes the system description.

3. The system of claim 1, wherein:
the initial conversation parameters further include an adversarial seed including at least one of an example topic, example query, or example conversation; and
the first conversational-input prompt further includes the adversarial seed.

4. The system of claim 3, wherein the adversarial seed includes at least a portion of a logged prior conversation with the LM-based application.

5. The system of claim 1, wherein the first simulated conversation is stored in a first set of simulated conversations, and the second simulated conversation is stored in a second set of simulated conversations.

6. The system of claim 5, wherein generating the feedback includes generating one or more metrics for the first set of simulated conversations.

7. The system of claim 6, wherein the one or more metrics include at least one of a relevance metric, an adversarial metric, and a diversity and coverage metric.

8. The system of claim 7, wherein the one or metrics include the diversity and coverage metric and the diversity and coverage metric is generated based on a cluster analysis of embeddings for the simulated conversations in the first set of simulated conversations.

9. The system of claim 5, wherein evaluating an RAI compliance of the LM-based application includes evaluating whether each simulated conversation in the second set of conversations violated the RAI guideline.

10. The system of claim 1, wherein evaluating the RAI compliance of the LM-based application further comprises:
generating an evaluation prompt including the RAI guideline, the second simulated conversation, and an instruction for the language model to determine if the second simulated conversation violated the RAI guidelines;
providing the evaluation prompt to the language model; and
receiving, from the language model in response to the evaluation prompt, a response indicating whether the second simulated conversation violated the RAI guideline.

11. The system of claim 1, wherein the LM-based application is a chatbot.

12. The system of claim 1, wherein the persona settings include a setting for at least one of a conscientiousness trait, an openness trait, an extraversion trait, a neuroticism trait, or an agreeableness trait.

13. A computer-implemented method for testing responsible artificial intelligence (RAI) compliance of a language model (LM) based application, the method comprising:
generating feedback for a first set of simulated conversations with the LM-based application;
based on the feedback, adjusting one or more conversation parameters, wherein the conversation parameters include one or more persona settings for a simulated user;
generating a second set of simulated conversations, wherein generating the second set of simulated conversations comprises:
generating a conversational-input prompt requesting a conversational input, wherein the conversational input prompt includes an RAI guideline and the persona settings;
providing the generated conversational-input prompt as input to a language model;
receiving, from the language model in response to the conversational-input prompt, the requested conversational input;
transmitting the conversational input to the LM-based application;
receiving a conversational response from the LM-based application in response to the conversational input;
storing the conversational response as part of a simulated conversation of the second set of simulated conversations; and
evaluating an RAI compliance of the second set of simulated conversations.

14. The method of claim 13, wherein the persona settings include settings for at least two of a conscientiousness trait, an openness trait, an extraversion trait, a neuroticism trait, or an agreeableness trait.

15. The method of claim 13, wherein evaluating in the RAI compliance of the LM-based application further comprises:
generating an evaluation prompt including the RAI guideline, the conversational response, and an instruction for the language model to determine if the conversational response violated the RAI guidelines;
providing the evaluation prompt to the language model; and
receiving, from the language model in response to the evaluation prompt, a response indicating whether the conversational response violated the RAI guideline.

16. The method of claim 15, further comprising generating an RAI compliance score based on whether the conversational response violated the RAI guideline.

17. A system for testing responsible artificial intelligence (RAI) compliance of a language model (LM) based application, the system comprising:
at least one processor; and
memory storing instructions that, when executed by the at least one processor, cause the system to perform operations comprising:
receiving initial conversation parameters, wherein the initial conversation parameters comprise:
an RAI guideline;
one or more persona settings for a simulated user; and
a system description of the LM-based application;
generating a first set of simulated conversations, with the LM-based application, based on the initial conversation parameters;
generating feedback based on the first set of simulated conversations;
adjusting one or more of the conversation parameters based on the generated feedback;
generating a second set of simulated conversations, with the LM-based application, based on the adjusted conversation parameters; and
evaluating an RAI compliance of the LM-based application based on whether the second set of simulated conversations violated the RAI guideline.

18. The system of claim 17, wherein:
the conversation parameters further include configuration settings for the language model, including at least one of a top-p value, a top-k value, or a temperature; and
adjusting the conversation parameters includes adjusting at least one of the configuration settings for the language model.

19. The system of claim 17, wherein evaluating the RAI compliance comprises:
generating an evaluation prompt including the RAI guideline, the second set of simulated conversations, and an instruction for a language model to determine if the simulated conversations violated the RAI guidelines;
providing the evaluation prompt to the language model; and
receiving, from the language model in response to the evaluation prompt, a response indicating whether the simulated conversations violated the RAI guideline.

20. The system of claim 17, wherein the initial conversation parameters are received through a configuration interface.
